(19) United States
(12) Patent Application Publication
(10) Pub. No.: US 2004/0080151 A1
(43) Pub. Date: Apr. 29, 2004

(54) Ski paraphernalia carrying basket for a chair ski lift

(76) Inventor: Morris William Hunt, Milton (CA)

Correspondence Address: CAHN & SAMUELS LLP, 2000 P STREET NW, SUITE 200, WASHINGTON, DC, 20036, US

(21) Appl. No.: 10/426,034

(22) Filed: Apr. 30, 2003

Related U.S. Application Data
(63) Continuation of application No. 09/778,745, filed on Feb. 8, 2001, now abandoned.
Application No. 09/778,745 is a continuation of application No. PCT/US99/00649, filed on Jan. 12, 1999.

(51) Int. Cl. B60R 9/00

(52) U.S. Cl. 280/809; 224/401

(57) ABSTRACT

An advertising ski paraphernalia basket is securely mounted in non-rotatable relation to a safety bar of a chair ski lift. The basket includes one or more surfaces on which is placed indicia, usually advertising. The advertising is preferably replaceable, making the basket a site for third party paid advertising exposed to a captive audience that produces a continuing revenue source. The chair ski lift safety bar is moveable in an arcuate path between a passenger safety position whereat the safety bar is disposed forwardly of an apex balance point in blocking relation in front of the chair portion of the chair ski lift, and an entry-exit position whereat the safety bar is disposed above and rearwardly of the chair portion of the chair ski lift and rearwardly of the apex balance point. The basket comprises a floor suitable for receiving ski paraphernalia, and walls extending upwardly from the floor about the periphery thereof. When the safety bar is in its passenger safety position, the basket is positioned so as to be readily accessible in a ski paraphernalia supporting orientation. When the safety bar moves in the arcuate path from the passenger safety position toward its entry-exit position, past the apex balance point, the basket reaches a dumping position whereat the floor of the basket is substantially inverted, thus causing any ski paraphernalia inadvertently remaining within the basket, to be dumped from the basket.

This application is a continuation of Ser. No. 09/778,745 filed Feb. 8, 2001 which is a continuation of PCT/US99/00649 filed Jan. 12, 1999.

### FIELD OF THE INVENTION

This invention relates to indicia in combination with ski paraphernalia carrying baskets for secure mounting onto chair ski lifts, specifically onto the safety bars thereof.

### DESCRIPTION OF THE PRIOR ART

Downhill skiing, also known as alpine skiing, has become a very popular sport over the past several decades. Typically, downhill skiing involves skiing down lengthy slopes, also known as a ski runs, of perhaps several hundred yards long to perhaps about a mile or more long, some of which ski runs are also quite steep in order to allow for expert skiers to obtain considerable speed. Accordingly, ski lifts are provided for carrying skiers from the bottom of the ski runs to the top of the ski runs.

The most common type of ski lift is a chair ski lift having a frame member suspended from a cable, a chair portion mounted on the frame member, and a substantially horizontally disposed elongate safety bar mounted on the chair portion for pivotal movement about a substantially horizontal pivot axis. The safety bar is selectively moveable in an arcuate path between a passenger safety position and an entry-exit position through manual manipulation of an elongate substantially horizontal handle disposed rearwardly of the chair portion. In the passenger safety position, the safety bar is disposed forwardly of an apex balance point and in blocking relation directly in front of the chair portion of the chair ski lift so as to preclude skiers sitting in the chair portion from unwantedly exiting the ski lift before reaching the top of the ski run. In the entry exit position, the safety bar is disposed above and rearwardly of the chair ski lift and rearwardly of the apex balance point, to permit easy ingress and egress of the skier or skiers from the chair.

When ascending a ski hill in a conventional chair ski lift, there is no place for a skier to temporarily set down various ski paraphernalia such as gloves, goggles, hats, and so on. Typically, goggles and hats simply remain in place on the skier's head, with the goggles removed from covering the eyes. However, it is quite common to remove one's gloves so as to wipe or blow the nose. If gloves, or even hats and goggles, are removed while in a chair ski lift, they must either be placed in one's lap, or on the chair portion of the ski lift. As a result, they tend to be dropped during the ascent up the ski run, and possibly not found subsequently. Ski gloves may also be clipped to the skier's jacket, but this is very inconvenient and is generally not done.

At the same time, a new trend in the advertising industry has been to develop new and innovative sites for the placement of revenue producing advertising. An outstanding example of this has been the placement of removable and replaceable third party paid advertising inside of golf holes. In the context of this invention, the term “third party” advertisement contemplates an arms length advertiser that is ordinarily neither the supplier of the invention nor the operator of the chair ski lift on which the invention is employed, although neither is precluded.

Typical of this type of technology are a number of issued U.S. patents. Examples are Boudreau, U.S. Pat. No. 4,928,417, Boudreau, et al., U.S. Pat. No. 4,878,665, Dark, U.S. Pat. No. 5,249,384, Hannon, U.S. Pat. No. 5,190,283, Hageman, U.S. Pat. No. 5,362,044, and Mabie, U.S. Pat. No. 5,788,581. So far as is presently known, there are no issued patents teaching the provision of a device for the storage of ski paraphernalia on a chair ski lift, and almost certainly there are no patents on the placement of removable and replaceable third party paid advertising on such a storage device on a chair ski lift.

Bearing in mind the foregoing, it is a principal object of the present invention to provide a site for removable and replaceable third party paid advertising in combination with ski paraphernalia baskets for use with a chair ski lift.

It is another object of the present invention to provide a site for removable and replaceable third party paid advertising in combination with a ski paraphernalia basket for use with a chair ski lift, which advertising site and basket are connected to the safety bar of a chair ski lift.

It is still a further object of the present invention to provide a site for removable and replaceable third party paid advertising in combination with a ski paraphernalia basket for use with a chair ski lift, which basket is unobtrusive during entry into and exit from a chair ski lift.

It is yet an another object of the present invention to provide a site for removable and replaceable third party paid advertising in combination with a ski paraphernalia basket for use with a chair ski lift, which basket effects dumping of ski paraphernalia inadvertently remaining within the basket, rearwardly of the chair portion of the ski lift when the safety bar is in the entry-exit position.

One more object of the invention is to provide a ski paraphernalia basket on a chair ski lift which includes at least one sight blocking panel disposed on the front and/or rear wall(s) of the basket to help preclude possible vertigo of skiers sitting in the ski lift chairs.

Various other objects, advantages, and features of the invention will become apparent to those skilled in the art from the following descriptions taken in conjunction with the appended drawings and claims.

### SUMMARY OF THE INVENTION

The present invention accomplishes the above stated objectives, as well as others, as may be determined by a fair reading and interpretation of the entire specification.

In accordance with a first aspect of the present invention, there is provided a ski paraphernalia basket for secure mounting to a substantially horizontally disposed elongate safety bar of a chair ski lift. In accordance with a second aspect of the invention, the basket includes one or more surfaces on which can be placed indicia that may be in the form of advertising. These surfaces will preferably be one or more sight blocking panels included to help avoid skier vertigo and the front sight blocking panel cover portion. For purposes of this invention, “indicia” refers to any means of communicating information, whether written, printed, visible, audible, etc. and not just solicitations to buy products or services. Further, the advertising may be of a type that is removable and replaceable, making the basket a site for third party paid advertising exposed to a captive audience that produces a continuing revenue source.

The ski paraphernalia basket is securely mounted on the safety bar of a chair ski lift. The safety bar is selectively moveable in an arcuate path between a passenger safety position whereat the safety bar is disposed forwardly of an apex balance point in blocking relation directly in front of the chair portion of the chair ski lift, and an entry-exit position whereat the safety bar is disposed above and rearwardly of the chair portion of the chair ski lift and rearwardly of the apex balance point. The basket comprises a floor suitable for receiving ski paraphernalia, and front, rear, left side, and right side walls extending upwardly from the floor about its periphery. The rear wall is sloped to face a skier seated in the chair lift. Mounting means are provided for securely mounting the basket to the substantially horizontally disposed elongate safety bar of the ski lift in non-rotatable relation about the safety bar. When the safety bar is in its passenger safety position, the basket is positioned so as to be readily accessible yet in non-blocking relation to passengers in the chair portion of the chair ski lift, and the floor and walls of the basket are in a ski paraphernalia supporting orientation. When the safety bar moves in the arcuate path from the passenger safety position toward its entry-exit position, past the apex balance point, the basket reaches a dumping position whereat the floor and walls of the basket are removed from their ski paraphernalia supporting orientation, and whereat the floor of the basket is substantially inverted, thus causing any ski paraphernalia inadvertently remaining within the basket, to be dumped from the basket.

With regard to the indicia, this is typically advertising copy, the preferred form being prepared for placement on a sight blocking panel. It may also be placed on the cover portion of the front sight blocking panel. The indicia is preferably computer generated advertising laminates printed and produced using high resolution laser output on 10 point opaque polyolefin plastic film and bonded to a transparent 30 point polycarbonate protective plate using clear double-sided permanent adhesive tape and a heat laminating unit. Placement on the sight blocking panel, preferably the rear one, is done using typical fastening means such as rivets through holes in register with each other drilled through the sight blocking panel, advertising laminate, and sight blocking panel end cap.

### BRIEF DESCRIPTION OF THE DRAWINGS

The novel features which are believed to be characteristic of the present invention, as to its structure, organization, and use, together with further objectives and advantages thereof, will be better understood from the following drawings in which a presently preferred embodiment of the advertising ski paraphernalia basket invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a perspective view of a preferred embodiment of the ski paraphernalia basket according to the present invention, installed on a chair ski lift;

FIG. 2 is a front elevational view of the ski paraphernalia basket of FIG. 1 as seen from a skier in the chair ski lift;

FIG. 3 is a rear elevational view of the ski paraphernalia basket of FIG. 1;

FIG. 4 is a top plan view of the advertising ski paraphernalia basket of FIG. 1;

FIG. 5 is a left end elevational view of the ski paraphernalia basket of FIG. 1;

FIG. 6 is a left end elevational view of the ski paraphernalia basket of FIG. 1, installed on a chair ski lift, with the safety bar in its passenger safety position;

FIG. 7 is a left end elevational view similar to FIG. 6, with the safety bar in its entry-exit position.

FIG. 8 is an exploded view of the third party paid advertising laminate prior to lamination.

FIG. 9 is an exploded view of the laminated advertising prior to assembly to the sight blocking panel.

### DETAILED DESCRIPTION OF THE PREFERRED EMBODIMENTS

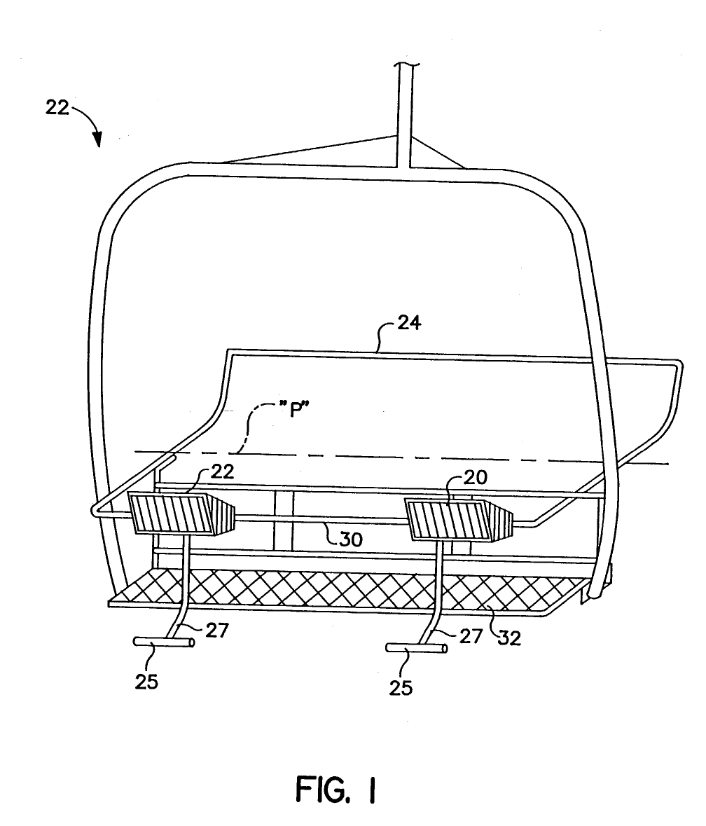

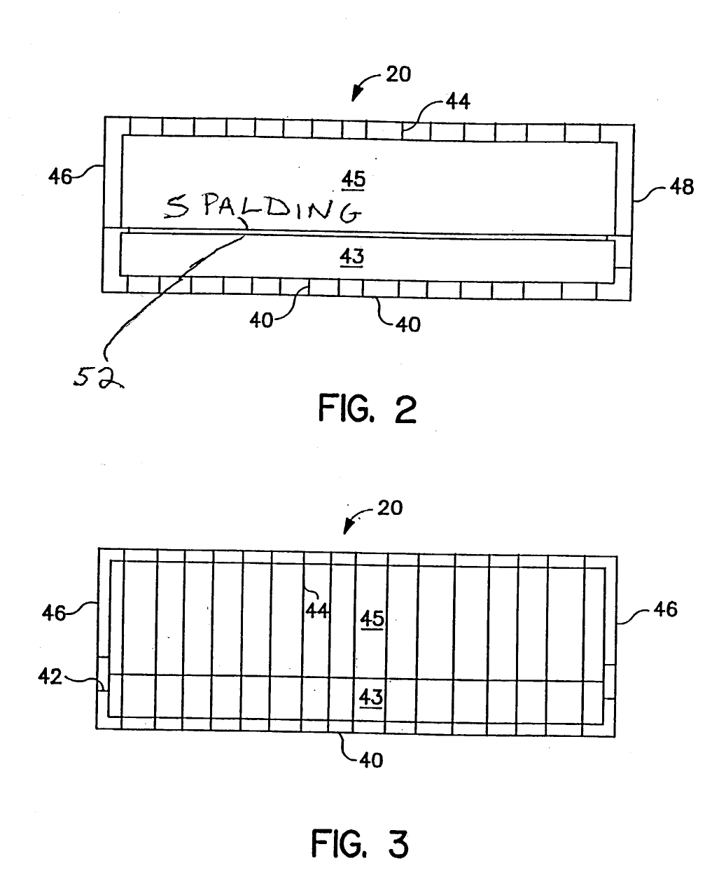

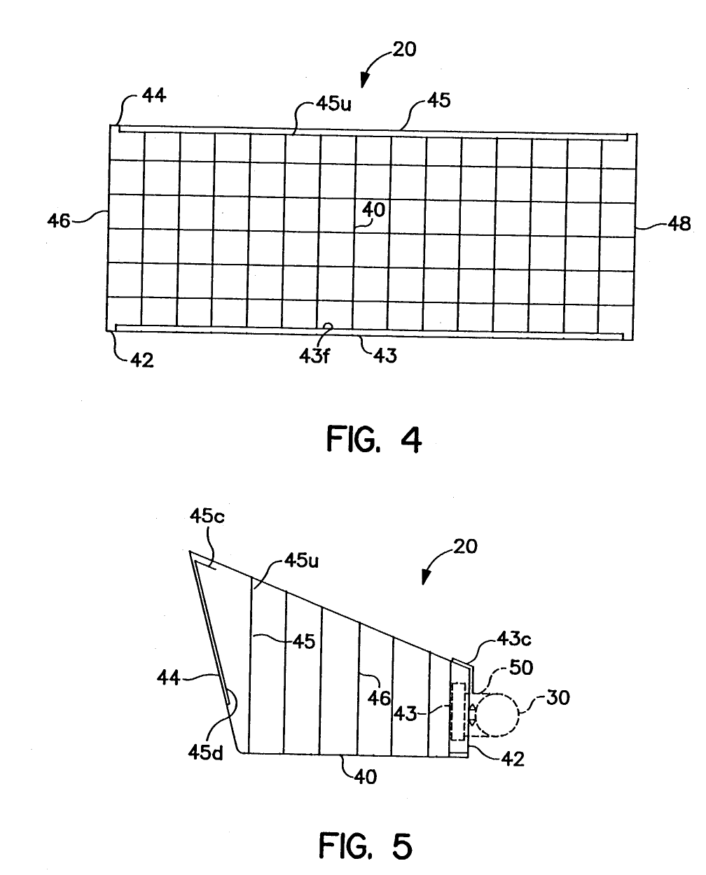

Reference will now be made to FIGS. 1 through 9, which show a ski paraphernalia basket for carrying ski gloves, goggles, hats and so on, while ascending a ski hill in a chair ski lift, as indicated by the general reference numeral 22. The chair ski lift 22 as shown in FIGS. 1, 6, and 7 is part of an overall ski lift apparatus (not shown). Chair ski lifts vary in design, but not significantly. Accordingly, the present discussion is applicable to virtually all chair ski lifts, no matter what specific features of design and geometry they may have.

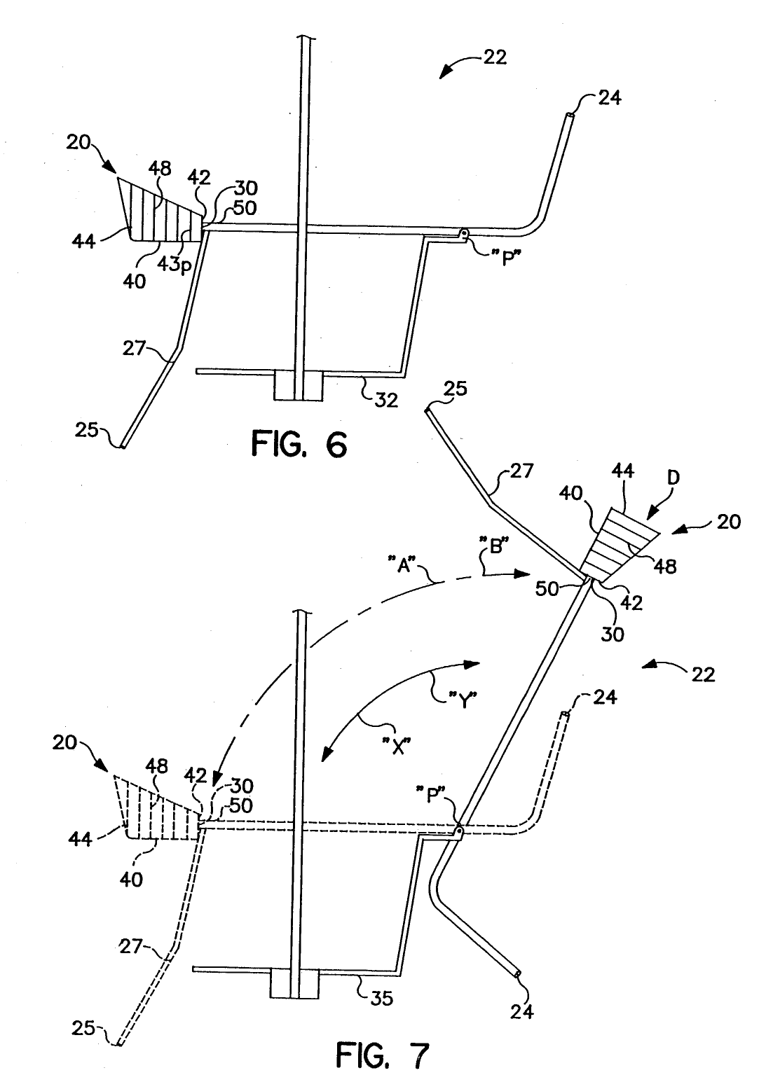

The ski paraphernalia basket 20 is securely mounted onto a substantially horizontally disposed elongate safety bar 30 of a chair ski lift 22, as can be best seen in FIGS. 1,6 and 7. The safety bar 30 of the chair ski lift 22 is mounted on the chair portion 32 of the chair ski lift 22 for pivotal movement about a substantially horizontal pivot axis “P” and is selectively manually moveable about the pivot axis “P”, as is indicated by arrows “X” and “Y”, by manipulation of elongate handle 24, in an arcuate path “A” between a passenger safety position, as illustrated by solid lining in FIG. 6 and by ghost outline in FIG. 7, and an entry-exit position, as illustrated by solid lining in FIG. 7.

In the passenger safety position, the safety bar 30 of the chair lift 22 is disposed forwardly of an apex balance point “B”, as can be best seen in FIG. 7, so as to remain in the passenger safety position without having to be latched in position. Also, the safety bar 30 is disposed in blocking relation directly in front of the chair portion 32 of the chair ski lift 22 so as to preclude skiers sitting in the chair portion 32 of the chair ski lift 22 from falling out while ascending a ski hill, before reaching the designated exit point. Typically, when the safety bar 30 is in its passenger safety position, it is also disposed substantially directly in front of its pivot axis “p” so as to permit initial vertical movement and subsequent vertical and rearward movement of the safety bar 30, to thereby not interfere with skiers in the chair lift 22.

In the entry exit position, the safety bar 30 is disposed above and rearwardly of the chair portion 32 of the chair ski lift 22, so as to be out of the way of skiers entering the chair ski lift 22 at the designated entry point at the bottom of the ski run or exiting the chair ski lift 22 at the designated exit point at the top if the ski run. In use, at the bottom of the ski run, the safety bar 30 is in its entry-exit position as it receives skiers for the ascent up the ski run. Once the skiers are seated in the chair portion 32 of the chair ski lift 22, the safety bar 30 is manually moved by a skier from its entry-exit position to its passenger safety position generally, by manipulating the elongate handle bar 24 and remains in the passenger safety position while the chair lift 22 is ascending the ski run. Once at the top of the ski run, the safety bar 30 is manually moved by a skier from its passenger safety position to its entry-exit position again, by manipulating the elongate handle bar 24 and remains in the entry-exit position while the chair lift 22 is descending the ski run.

Further, in the entry-exit position, the safety bar 30 is disposed rearwardly of the apex balance point “8” in order to create a moment about the substantially horizontal pivot axis “P”, thus causing the safety bar 30 to be retained by gravity in its entry-exit position, without being latched in position, until it is purposefully moved to its passenger safety position. Preferably, the ski paraphernalia basket 20 is also disposed rearwardly of the apex balance point “8”, to augment the moment of the safety bar 30 about the substantially horizontal pivot axis “P”, thus assisting the safety bar 30 to remain in its entry-exit position. As can be seen in FIGS. 1, 6, and 7, the ski paraphernalia basket 20 is mounted so as to be disposed forwardly of the safety bar 30 when the safety bar 30 is in its passenger safety position, and is therefore disposed rearwardly of the safety bar 30 when the safety bar 30 is in its entry-exit position, thus further augmenting the moment arm. Accordingly, the safety bar 30 is inherently more stable in its entry-exit position, and is less likely to unwantedly or unexpectedly flip to its passenger safety position during the descent of the chair lift 22 to the elongate handle bar 24, tends to counterbalance the footrest(s) 25 and the support bar(s) 27 therefor, at least a portion of which may be disposed forwardly of the substantially horizontal pivot axis “pit as the chair lift 22 descends the hill.

The basket 20 comprises a substantially flat floor 40 suitable for receiving ski paraphernalia, a front wall 42, a rear wall 44 which is sloped to squarely face a skier in the chair lift, a left side wall 46, and a right side wall 48. The front, rear, left side, and right side walls 42, 44, 46, 48 are joined one to another and extend upwardly about the periphery of the floor 40. In the preferred embodiment, the front wall 42 is shorter than the rear wall 44 to permit ready access to ski paraphernalia retained in the basket 20 and to facilitate viewing by skiers in the chair lift of the advertising or other indicia 52 on the sloped rear wall 44. The top edge of left and right side walls 46, 48 are accordingly also sloped downwardly from rear to front.

In the preferred embodiment as illustrated, the floor 40 and the front, rear, left side, and right side walls 42, 44, 46,48 are made from wire mesh coated with a suitable plastic or synthetic rubber material. In this manner, the floor 40 and the front, rear, left side, and right side walls 42, 44, 46, 48 each have a plurality of openings therein to accommodate snow and water drainage therethrough. Also wind resistance is minimized, so as to substantially preclude the possibility of the wind blowing against the basket 20 strongly enough to unexpectedly move the safety bar 30 from either of its passenger safety position or its entry-exit position.

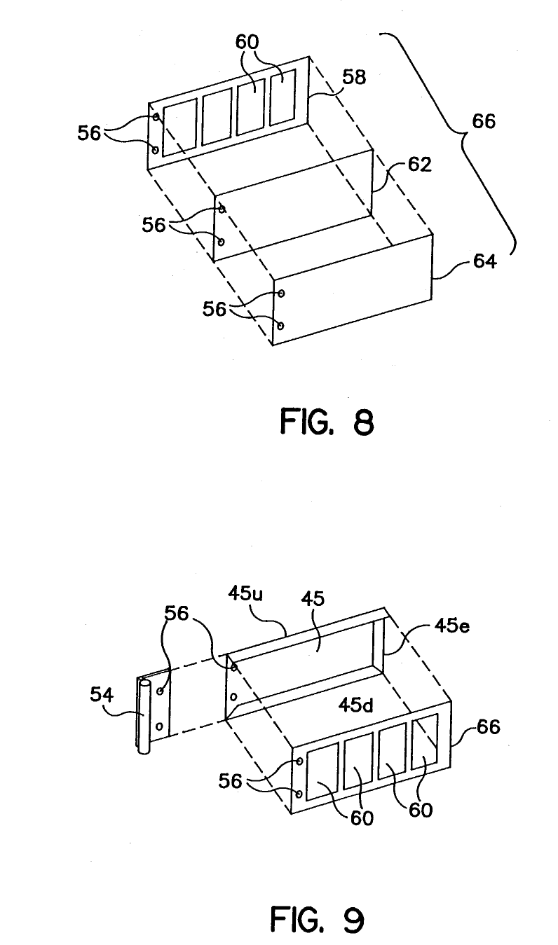

The front wall 42 and the sloped rear wall 44 each include a substantially opaque sight blocking portion 43,45 respectively, to preclude viewing therethrough. In the preferred embodiment, the substantially opaque sight blocking 43, 45 comprise a substantially solid front sight blocking panel 43 disposed on the front wall 42 and a substantially solid rear sight blocking panel 45 disposed on the rear wall 44. In regard to the rear sight blocking panel 45, the same may act as a mounting surface for the advertising or other indicia 52, or it may be integral therewith. The solid front sight blocking panel 43 helps to preclude the unintentional or unwanted passage of fingers through the openings in the front wall 42, thus avoiding possible injury. The substantially solid front sight blocking panel 43 and the substantially solid rear sight blocking panel 45 may be formed from sheet metal for the sake of toughness and resistance to cold temperatures, and may be secured to the front wall 42 and the rear wall 44 respectively, by means of welding, before the plastic or synthetic rubber material is applied. Generally, the substantially solid front sight blocking panel 43 is stepped for receiving the nut portion of size-adjustable metal strap clamps 50, or other suitable clamping devices, between a lower protrusion 43p and the front wall 42, as seen in FIG. 6. More usually, however, the front sight blocking panel 43 is formed with a cover portion 43c which overlies the metal strap clamps 50, and which provides for a smooth upper edge for the front wall 42, as shown in FIG. 5. The substantially solid rear sight blocking panel 45 generally is formed to have upper and lower lips 45u, 45l for receiving and retaining indicia inserts on the rear sight blocking panel 45. These indicia inserts will be described hereinafter in connection with FIGS. 8 and 9. Additionally, the cover portion 43c of the front sight blocking panel 43 has further indicia which may be removable as well.

It has been found during testing of the present invention that a wire mesh basket without front and rear sight blocking portions, and mounted on a chair ski lift 22, may tend to cause vertigo for skiers sitting in the chair portion 32 of the chair ski lift 22, since the basket 20 is mounted directly in the line of sight of a skier sitting in the chair portion 32. Accordingly, the substantially solid front and rear sight blocking panels 43, 45 disposed on the front and rear walls 42, 43 respectively help preclude possible vertigo of skiers sitting in the chair portion 32 of the chair lift 22.

A typical mounting means for the basket 20 preferably comprises a pair of size adjustable metal strap clamps 50 secured in spaced apart relation to the basket 20 and looped around the safety bar 30 in frictionally engaging relation thereto. The size adjustable metal strap clamps 50 securely mount the basket 20 to the substantially horizontally disposed elongate safety bar 30 of the chair lift 22 in non-rotatable relation about the safety bar 30.

As can best be seen in FIG. 6, when the safety bar 30 is in its passenger safety position, the carrying basket 20 is positioned so as to be readily accessible, yet in non-blocking relation to passengers in the chair portion 32 of the chair ski lift 22. Also, the floor 40 and front, rear, left side, and right side walls 42, 44, 46,48 of the basket 20 are in a ski paraphernalia supporting orientation, preferably substantially horizontally oriented, thus permitting ski paraphernalia, such as ski gloves, goggles, hats, and so on, to be retained therein during the ride while a skier is ascending a ski hill in a chair ski lift 22.

When the safety bar 30 moves in the arcuate path “A” from the passenger safety position toward its entry-exit position, as indicated by arrow “Y” in FIG. 7, past the apex balance point “B”, the basket 20 reaches a dumping position, as indicated by arrow “D” in FIG. 7. The dumping position “D” may be reached either before the entry-exit position of the safety bar 30 or at the entry-exit position of the safety bar 30. In the dumping position, the floor 40 and the front, rear, left side, and right side walls 42, 44, 46, 48 of the basket 20 are removed from their ski paraphernalia supporting orientation. Further, the floor 40 of the basket 20 is substantially inverted, thus causing any ski paraphernalia inadvertently remaining within the basket 20, to be dumped from basket 20 onto the ground below the chair ski lift 22. In this manner, the dumped ski paraphernalia may be immediately recovered, instead of being retained in the basket and probably not recovered.

It is undesirable to dump any ski paraphernalia inadvertently remaining within the basket 20 onto the skiers in the chair portion 32 of the chair ski lift 22 as this would be quite startling. Moreover, in the event that a hard or somewhat heavy object remains in the basket 20, injury could result.

It can be seen and understood by way of the above description and accompanying drawings that the ski paraphernalia basket 20 of the present invention provides a ski paraphernalia basket 20 for use with a chair ski lift 22, which basket 20 is connected to the safety bar 30 of a chair ski lift 22 and is unobtrusive during use of a chair ski lift 22, including during entry into and exit from a chair ski lift 22. The ski paraphernalia basket 20 of the present invention also effects dumping rearwardly of the chair portion 32 of the ski lift of any ski paraphernalia inadvertently remaining within the baskets 20.

Turning to FIG. 8, there is illustrated an exploded perspective view of advertising laminate 66. It is composed of three layers beginning with advertisement substrate 58 on to which has been preferably placed anywhere from 1 to 4 advertisements. This is preferably done with computer generated advertising plates which are printed and produced using a high resolution laser output on 10 point opaque polyolefin plastic film. The second layer is sided adhesive film 62. The third layer protective layer 64, which is preferably comprised of 30 point polycarbonate. These three layers are laminated together by passing them through a conventional laminating unit (not shown). The product is also die cut to finished size (not shown) and drilled with fastener holes 56.

FIG. 9 is an exploded perspective view illustrating how the advertising laminate 66 is assembled to the rear sight blocking panel 45. The rear sight blocking includes an upper lip 45u, lower lip 45l and side lip 45s. The advertising laminate is placed on the surface blocking panel 45 within the foregoing lips and with fastener holes 56 in registration with similar fastener holes 56 previously placed in rear sight blocking panel 45. Then end cap 54, which also has fastener holes 56 is attached to the foregoing, and conventional fasteners such as rivets or screws (not shown) are used to connect to the entire assembly together for placement in the basket.

It is apparent that the foregoing assembly can readily disassembled without even removing the sight blocking panel 45 from the basket for the purpose of removing and replacing the advertising copy 60 on a regular basis.

While the invention has been described, disclosed, illustrated and shown in various terms or certain embodiments or modifications which it has assumed in practice, scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. An advertising ski paraphernalia basket for a chair ski lift having a pivotally moveable safety bar, said basket comprising:
a floor suitable for receiving ski paraphernalia;
walls extending up from the floor about its periphery; at least one clamp fixedly mounting the basket to the safety bar; and
indicia attached to the basket.

2. The basket of claim 1 in which the indicia is replaceable advertising.

3. The basket of claim 1 in which the at least one clamp comprises a pair of size adjustable metal straps secured in spaced apart relation to the basket and looped around the safety bar in frictionally engaging relation thereto.

4. The basket of claim 1 in which the walls include a front wall and a sloped rear wall at least one of which includes a substantially opaque portion to preclude viewing therethrough.

5. The basket of claim 1 in which the floor has a plurality of openings therein to accommodate snow and water drainage therethrough.

6. The basket of claim 1 in which the floor is made from wire mesh.

7. The basket of claim 1 in which the walls each have a plurality of openings therein to accommodate snow and water drainable therethrough.

8. The basket of claim 1 in which the walls are made from wire mesh.

9. The basket of claim 1 in which the walls are adjoined one to another.

10. A method for displaying an advertisement on a chair ski lift having a pivotably movable safety bar comprising:
fixedly mounting a ski paraphernalia basket on the safety bar; and
attaching indicia to the basket.

11. A ski paraphernalia carrying basket for secure mounting to a substantially horizontally disposed elongate safety bar of a chair-type ski lift; wherein said safety bar is selectively moveable in an accurate path between a passenger safety position whereat said safety bar is disposed forwardly of an apex balance point in blocking relation directly in from of the chair portion of said chair-type ski lift, and an entry-exit position whereat said safety bar is disposed above and rearwardly of the chair portion of said chair-type ski lift and rearwardly of said apex balance point; said carrying basket comprising:
a floor suitable for receiving ski paraphernalia;
front, rear, left side, and right side walls extending upwardly from said floor; and
mounting means for securely mounting said carrying basket to said substantially horizontally disposed elongate safety bar of said ski lift in non-rotatable relation about said safety bar;
wherein, when said safety bar is in its passenger safety position, said carrying basket is positioned so as to be readily accessible yet in non-blocking relation to passengers in the chair positioned so as to be readily accessible yet in non-blocking relation to passengers in the chair position of said chair-type ski lift, and said floor and side walls of said carrying basket are in a ski paraphernalia supporting orientation; and
wherein, when said safety bar moves in said arcuate path from said passenger safety position toward its entry-exit position, past said apex balance point, said carrying basket reaches a dumping position whereat said floor and side walls of said carrying basket are removed from their ski paraphernalia supporting orientation, and whereat said floor of said carrying basket is substantially inverted, thus causing any ski paraphernalia inadvertently remaining within said carrying basket, to be dumped from said basket.

12. The basket of claim 1 wherein the walls comprise a front wall and a rear wall, the rear wall including a sight blocking panel, and an advertising laminate disposed on the sight blocking panel.

13. The basket of claim 3 wherein the walls include a front wall having a substantially opaque portion to preclude viewing therethrough and a rear wall having a substantially opaque portion to preclude viewing therethrough.

14. The method of claim 10 wherein attaching indicia to the basket includes attaching an advertising laminate to a rear wall of the basket.

15. In combination, a ski paraphernalia carrying basket and a chair ski lift, the combination comprising:
a chair ski lift having a chair portion, a safety bar positioned to restrain occupants of the chair portion and a foot rest extending from the safety bar; and
the ski paraphernalia carrying basket of claim 1, wherein the basket is mounted to the safety bar such that the basket is disposed forward of the safety bar when the safety bar is in a first position and the basket is disposed rearward of the safety bar when the safety bar is in a second position.
